(19) United States
(12) Patent Application Publication
(10) Pub. No.: US 2026/0339237 A1
(43) Pub. Date: Oct. 29, 2026

(54) IMAGE FORMING APPARATUS

(71) Applicant: KYOCERA Document Solutions Inc., Osaka (JP)

(72) Inventors: Tamotsu SHIMIZU, Osaka (JP); Norio KUBO, Osaka (JP); Shiori KIHARA, Osaka (JP)

(73) Assignee: KYOCERA Document Solutions Inc., Osaka (JP)

(21) Appl. No.: 19/649,969

(22) Filed: Apr. 16, 2026

(30) Foreign Application Priority Data
Apr. 25, 2025 (JP) 2025-073483

(51) Int. Cl. G03G 15/08; G03G 15/00

(52) U.S. Cl. CPC G03G 15/0896; G03G 15/5004; G03G 15/80; G03G 2215/00978; G03G 2215/0609

(57) ABSTRACT

An image forming apparatus includes an image carrier, a developer carrier, a development power supply, a current detection unit, and a control unit. The control unit detects a developing current while changing a DC component of a developing voltage in a plurality of steps, and predicts states of fogging and carrier development, on the basis of the developing current and a gradient of change in the developing current with respect to change in the DC component of the developing voltage, when the DC component of the developing voltage is the same as a surface potential of the image carrier, and the developing current and a gradient of change in the developing current with respect to change in the DC component of the developing voltage, when the DC component of the developing voltage is a voltage for image formation by the developer carrier.

### INCORPORATION BY REFERENCE

This application is based upon and claims the benefit of priority from the corresponding Japanese Patent Application No. 2025-073483 filed Apr. 25, 2025, the entire contents of which are hereby incorporated by reference.

### BACKGROUND

The present disclosure relates to an image forming apparatus.

Conventionally, it is performed to determine a surface potential of a photosensitive drum (image carrier) in an image forming apparatus using a two-component developer. For instance, conventionally, a developing current is measured, and the surface potential of the photosensitive drum is determined from the measurement result.

### SUMMARY

An image forming apparatus according to a first aspect of the present disclosure includes an image carrier, a developer carrier, a development power supply, a current detection unit, and a control unit. The image carrier has a surface on which an electrostatic latent image is formed. The developer carrier has a developer carrying surface configured to carry a two-component developer containing toner and carrier, and develops the electrostatic latent image with the toner on the developer carrying surface, so as to form an image. The development power supply applies the developer carrier with a developing voltage including a DC component. The current detection unit outputs a value corresponding to a developing current flowing between the developer carrier and the image carrier when the developing voltage is applied to the developer carrier. The control unit detects the developing current on the basis of the output of the current detection unit. The control unit detects the developing current while changing the DC component of the developing voltage in a plurality of steps, and predicts states of fogging and carrier development, on the basis of the developing current and a gradient of change in the developing current with respect to change in the DC component of the developing voltage, when the DC component of the developing voltage is the same as a surface potential of the image carrier, and the developing current and a gradient of change in the developing current with respect to change in the DC component of the developing voltage, when the DC component of the developing voltage is a voltage for image formation by the developer carrier.

### BRIEF DESCRIPTION OF THE DRAWINGS

FIG. 1 is a schematic diagram of an image forming apparatus according to an embodiment.

FIG. 2 is a schematic diagram of a developing device and its vicinity according to the embodiment.

FIG. 3 is a block diagram of a power supply control system according to the embodiment.

FIG. 4 is a graph illustrating a relationship between a developing voltage and a developing current according to the embodiment.

FIG. 5 is a graph illustrating a relationship among the developing current, a fogging current, and a magnetic brush current according to the embodiment.

FIG. 6 is a schematic diagram for explaining a measurement method of a carrier resistance of a developer according to the embodiment.

FIG. 7 is a graph illustrating a result of an experiment performed for checking effects of the present disclosure (effects related to fogging).

FIG. 8 is a graph illustrating a result of an experiment performed for checking effects of the present disclosure (effects related to carrier development).

### DETAILED DESCRIPTION

### <1. Image Forming Apparatus>

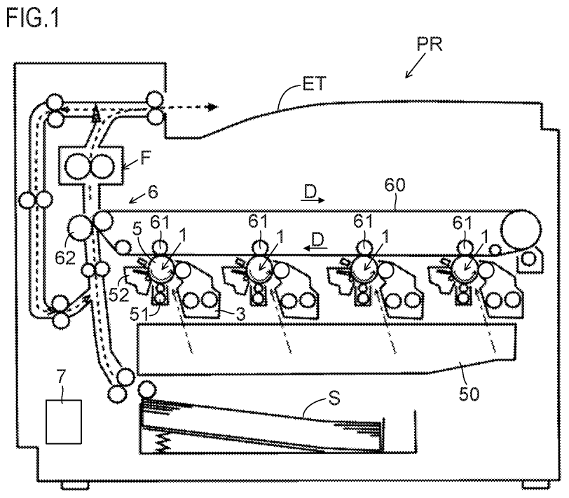

Hereinafter, with reference to FIG. 1, an image forming apparatus PR of this embodiment is described. The image forming apparatus PR is a printer.

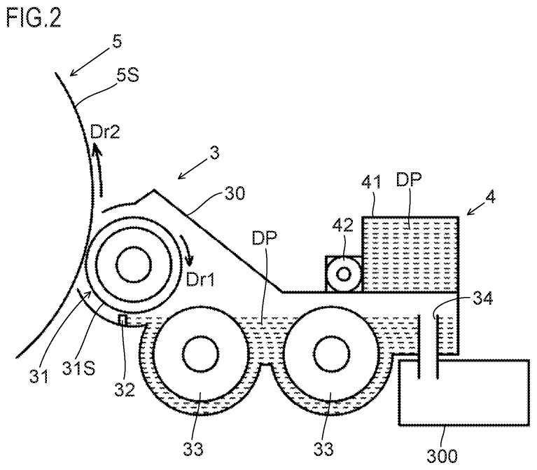

The image forming apparatus PR uses a developer DP (see FIG. 2) so as to perform electrophotographic printing on a sheet S as a recording medium. Note that the developer DP is a two-component developer, and it contains toner (an aggregate of toner particles) and carrier (an aggregate of carrier particles).

The image forming apparatus PR has a conveying path. In FIG. 1, the conveying path is shown by a broken line arrow. The image forming apparatus PR supplies the sheet S stored in a cassette to the conveying path, and conveys the sheet S along the conveying path. In this way, the sheet S passes through a transfer position and a fixing position in this order, and then it is discharged onto a discharge tray ET. At the transfer position, a transferring process is performed on the sheet S. At the fixing position, a fixing process is performed on the sheet S.

The image forming apparatus PR includes four image forming units 1 corresponding to four colors, i.e., cyan, magenta, yellow, and black colors. Each of the image forming units 1 forms an image using toner of the corresponding color. Hereinafter, one of the image forming units 1 is noted and a structure thereof is described. The image forming units 1 have the same basic structure. Therefore, descriptions of structures of other image forming units 1 are omitted by citing the following description.

The image forming unit 1 includes a developing device 3. The developing device 3 is connected to a replenishment unit 4 (see FIG. 2). The details will be described later.

In addition, the image forming unit 1 includes a photosensitive drum 5. The photosensitive drum 5 corresponds to an “image carrier”. The photosensitive drum 5 has an image carrying surface 5S (FIG. 1 does not show the numeral). A surface (outer peripheral surface) of the photosensitive drum 5 is the image carrying surface 5S.

The image forming unit 1 further includes a charging device 51 and a cleaning device 52. The photosensitive drum 5 constitutes one unit together with the charging device 51 and the cleaning device 52. Note that the image forming unit 1 includes an exposure device 50. There is one exposure device 50, which is shared by the image forming units 1.

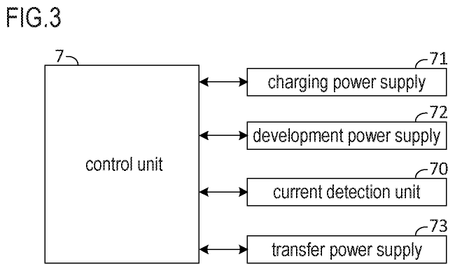

When the image forming unit 1 forms an image, the photosensitive drum 5 rotates. The charging device 51 is supplied with a charging voltage from a charging power supply 71 (see FIG. 3). The charging device 51 charges the photosensitive drum 5. In this way, the image carrying surface 5S is charged at a predetermined potential. The exposure device 50 exposes the image carrying surface 5S so as to form an electrostatic latent image on the image carrying surface 5S. The developing device 3 feeds toner to the electrostatic latent image on the image carrying surface 5S, so as to develop the electrostatic latent image with the toner. In this way, a toner image (an image) is formed on the image carrying surface 5S. The cleaning device 52 removes residual toner on the image carrying surface 5S.

The image forming apparatus PR includes a transfer unit 6. The transfer unit 6 transfers the toner image on the image carrying surface 5S of each photosensitive drum 5 to a sheet S. In other words, the transfer unit 6 transfers the toner image developed by each developing device 3 onto the sheet S.

The transfer unit 6 includes an intermediate transfer belt 60. The intermediate transfer belt 60 is an endless belt. The intermediate transfer belt 60 contacts the image carrying surface 5S of each photosensitive drum 5, and moves (rotates) in a direction shown by an arrow D in the contact state.

The transfer unit 6 includes primary transfer rollers 61. There are a plurality of the primary transfer rollers 61, which are allotted to cyan, magenta, yellow, and black colors, respectively. The primary transfer rollers 61 are disposed on an inner peripheral side of the intermediate transfer belt 60. Each primary transfer roller 61 is disposed to face the photosensitive drum 5 that carries a toner image of a corresponding color, via the intermediate transfer belt 60 between them.

In addition, the image forming apparatus PR includes one secondary transfer roller 62. The secondary transfer roller 62 is pressed to contact an outer peripheral surface of the intermediate transfer belt 60 at a transfer position. The secondary transfer roller 62 forms a transfer nip between itself and the intermediate transfer belt 60. In other words, the transfer nip is formed at the transfer position.

In a print job, the sheet S is conveyed to the transfer position (i.e., the transfer nip). The sheet S that is being conveyed passes through the transfer nip.

The intermediate transfer belt 60 receives primary transfer of the toner image from each photosensitive drum 5. The intermediate transfer belt 60 rotates while carrying the toner image on the outer peripheral surface. While the sheet S is passing through the transfer nip, the sheet S contacts the outer peripheral surface of the intermediate transfer belt 60. In this way, the toner image is secondarily transferred to the sheet S that is passing through the transfer nip.

The image forming apparatus PR includes a fixing unit F. The fixing unit F includes a heating roller and a pressure roller. The heating roller includes a heater inside. The pressure roller is pressed to contact the heating roller. The heating roller and the pressure roller contact each other so as to form a fixing nip at a fixing position.

In a print job, the sheet S after the transfer process passes through the fixing nip. In other words, the sheet S is sandwiched between the heating roller and the pressure roller of the fixing nip. The fixing unit F heats the sheet S that is passing through the fixing nip. At the fixing nip, the sheet S is pressed. The fixing unit F performs heating and pressing on the sheet S after the transfer process passes, so as to fix the toner image to the sheet S. After the fixing process, the sheet S is discharged onto the discharge tray ET.

In addition, the image forming apparatus PR includes a control unit 7. The control unit 7 controls the image forming apparatus PR.

### <2. Developing Device>

Hereinafter, with reference to FIG. 2, the developing device 3 of this embodiment is described.

The developing device 3 uses the developer DP so as to develop the electrostatic latent image. A developing method of the developing device 3 is a trickle development method. The developing device 3 receives replenishment of the developer DP from the replenishment unit 4. In other words, the image forming apparatus PR includes the replenishment unit 4 in addition to the developing device 3. The replenishment unit 4 may be one component of the developing device 3.

The developing device 3 includes a development casing 30. The developer DP is stored inside the development casing 30 in advance. The developing device 3 uses the developer DP stored in the development casing 30 so as to perform development.

The developing device 3 includes a developing roller 31. The developing roller 31 corresponds to a “developer carrier”. The developing roller 31 has a developer carrying surface 31S. A surface (outer peripheral surface) of the developing roller 31 is the developer carrying surface 31S.

The developing roller 31 is disposed inside the development casing 30 and is supported in a rotatable manner. The developer carrying surface 31S of the developing roller 31 is partially exposed from inside to outside of the development casing 30. Specifically, the development casing 30 has an opening at a position facing the image carrying surface 5S. From this opening, the developer carrying surface 31S is partially exposed to the outside. In this way, the developer carrying surface 31S and the image carrying surface 5S are disposed to face each other.

The developing roller 31 carries the developer DP on the developer carrying surface 31S, and supplies toner in the developer DP to the electrostatic latent image on the image carrying surface 5S. In this case, the developing roller 31 and the photosensitive drum 5 rotate individually. In FIG. 2, a rotation direction of the developing roller 31 is shown by an arrow Dr1, and a rotation direction of the photosensitive drum 5 is shown by an arrow Dr2.

The developing roller 31 includes a sleeve and a magnet roll. The sleeve is supported in a rotatable manner. The developer DP is carried on an outer peripheral surface of the sleeve. The magnet roll is disposed inside (in the cylinder) of the sleeve. The magnet roll is supported in a non-rotatable manner. The magnet roll has a plurality of magnetic poles in a circumferential direction. The sleeve can rotate about an axis of the magnet roll.

The developing device 3 includes a regulating blade 32. The regulating blade 32 is attached to the development casing 30. The regulating blade 32 has a distal end part disposed close to the developer carrying surface 31S. The distal end part of the regulating blade 32 is disposed on an upstream side of the facing region between the developing roller 31 and the photosensitive drum 5 in the rotation direction of the developing roller 31.

The developing device 3 includes two stirring screws 33. Each of the stirring screws 33 is disposed inside the development casing 30 and is supported in a rotatable manner. Each of the stirring screws 33 has a structure in which a helical blade is disposed on a rotation shaft. Each of the stirring screws 33 rotates so as to stir and convey the developer DP, while charging the toner in the developer DP.

During rotation of the developing roller 31, the developer DP (specifically, the carrier carrying the toner) is attracted to the developer carrying surface 31S by a magnetic force of the magnet roll, and a magnetic brush is formed on the developer carrying surface 31S. When the magnetic brush passes through between the developing roller 31 and the regulating blade 32, the magnetic brush is regulated to have a constant layer thickness. Then, the magnetic brush on the developer carrying surface 31S contacts the image carrying surface 5S.

In addition, the developing roller 31 is applied with a developing voltage including a DC component from a development power supply 72 (see FIG. 3). The developing voltage is a voltage in which an AC voltage (an AC component) is superimposed on a DC voltage (the DC component). Because the developing roller 31 is applied with the developing voltage having the same polarity as the toner, a potential difference is generated between the developing roller 31 and the photosensitive drum 5. This potential difference allows the toner in the magnetic brush to move from the developing roller 31 to the photosensitive drum 5.

The photosensitive drum 5 carries the toner, which is moved from the magnetic brush on the developer carrying surface 31S, on the image carrying surface 5S. The toner is supplied to the electrostatic latent image on the image carrying surface 5S (to parts whose potentials are decreased by exposure). In this way, the electrostatic latent image on the image carrying surface 5S is developed into the toner image.

The developing device 3 includes a discharge path 34. The discharge path 34 connects an inside of the development casing 30 and a collection box 300. In this way, excessive developer DP flows into the discharge path 34, flows along the discharge path 34, and reaches the collection box 300. In other words, the collection box 300 stores the excessive developer DP.

The replenishment unit 4 includes a container 41 and a replenishment member 42. The container 41 stores replenishment developer. The replenishment member 42 replenishes the replenishment developer stored in the container 41 to the developing device 3. For instance, the replenishment member 42 includes a screw shaft. When the screw shaft rotates, the replenishment developer is replenished from the container 41 to the inside of the development casing 30.

Note that the developing device 3 is equipped with a T/C sensor. The T/C sensor is connected to the control unit 7 (see FIG. 1). The T/C sensor detects a mixing ratio between the toner and the carrier inside the development casing 30. On the basis of an output of the T/C sensor, the control unit 7 controls replenishment of the replenishment developer from the replenishment unit 4 to the developing device 3. In other words, the control unit 7 controls the replenishment member 42 (to rotate and stop the screw shaft).

The T/C sensor is a magnetic permeability sensor, and outputs a value corresponding to a magnetic permeability of the developer DP inside the development casing 30. As the ratio of the carrier inside the development casing 30 is higher, the magnetic permeability of the developer DP inside the development casing 30 is higher. Utilizing this fact, the mixing ratio between the toner and the carrier inside the development casing 30 is detected. Then, a toner remaining amount inside the development casing 30 can be detected from the detected mixing ratio.

When starting to use the developing device 3, the development casing 30 already stores initial developer inside. The initial developer is the developer DP stored inside the development casing 30 when the image forming apparatus PR is shipped (before a user uses the image forming apparatus PR).

After starting use of the developing device 3, when the print job is performed, the developer DP inside the development casing 30 is consumed. In other words, the initial developer decreases inside the development casing 30. For this reason, after starting use of the developing device 3, the replenishment developer is replenished from the replenishment unit 4 to the developing device 3. The developer DP stored in the container 41 is the replenishment developer.

When the image forming apparatus PR continues the print job, the developer DP is replenished into the development casing 30 while developer DP is discharged from the inside of the development casing 30. In this way, the developer DP inside the development casing 30 is gradually changed, i.e., the initial developer is gradually replaced by the replenishment developer. In other words, inside the development casing 30, the initial developer and the replenishment developer are mixed.

### <3. Power Supply Control System>

Hereinafter, with reference to FIG. 3, a power supply control system (including the control unit 7) of this embodiment is described.

The control unit 7 includes processing circuits such as a CPU and an ASIC. The control unit 7 includes a memory such as a ROM and a RAM. The control unit 7 controls each component of the image forming apparatus PR on the basis of a control program and control data. For instance, the control unit 7 performs various calculations, image processing, communication processing, and the like. The control unit 7 controls various drive sources (a motor, a solenoid, and the like). The control unit 7 detects output values of the various sensors.

The image forming apparatus PR includes the charging power supply 71, the development power supply 72, and a transfer power supply 73. The charging power supply 71 applies the charging device 51 (a charging roller) with the charging voltage. In this way, a surface potential of the photosensitive drum 5 can be set to a desired potential. The development power supply 72 applies the developing roller 31 with a developing voltage. The transfer power supply 73 applies the primary transfer rollers 61 and the secondary transfer roller 62 with transfer voltages, respectively. The transfer voltage has a polarity opposite to the toner.

The control unit 7 includes a voltage control circuit. The control unit 7 controls the charging power supply 71, the development power supply 72, and the transfer power supply 73. In other words, the control unit 7 controls voltage application to various members for image formation, such as the developing roller 31.

In addition, the image forming apparatus PR includes a current detection unit 70. The current detection unit 70 detects a developing current flowing between the developing roller 31 and the photosensitive drum 5. When the developing roller 31 is applied with the developing voltage, a value corresponding to the developing current flowing between the developing roller 31 and the photosensitive drum 5 is output from the current detection unit 70.

The control unit 7 is connected to the current detection unit 70. On the basis of an output of the current detection unit 70, the control unit 7 detects the developing current flowing between the developing roller 31 and the photosensitive drum 5.

### <4. State Prediction of Fogging and Carrier Development>

The surface potential of the photosensitive drum 5 is sensitive to temperature, and if the temperature in the apparatus has a difference between when the image forming apparatus PR is powered on and when printing is finished, the surface potential of the photosensitive drum 5 will change. Naturally, an ambient temperature and humidity around the apparatus, and the number of printed sheets also affects the surface potential of the photosensitive drum 5. For this reason, when setting development conditions for development by the developing device 3, it is necessary to select conditions resistant to fluctuation of the surface potential of the photosensitive drum 5.

Here, in the development using the developer DP (i.e., the two-component developer), the fluctuation of the surface potential of the photosensitive drum 5 directly causes occurrence of fogging, in which the toner adheres to non-image regions of the photosensitive drum 5. In addition, the fluctuation of the surface potential of the photosensitive drum 5 directly causes occurrence of carrier development, in which the carrier adheres to the photosensitive drum 5.

If a state occurs where at least one of fogging and carrier development can occur, it is preferred to change the development conditions. However, even if a level of fogging or carrier development is a visually recognized level, an actually produced amount thereof is too small to measure on the main body side.

Therefore, in this embodiment, the control unit 7 detects the developing current on the basis of the output of the current detection unit 70. The control unit 7 changes the DC component of the developing voltage in a plurality of steps, and detects the developing current in each step. Then, the control unit 7 predicts states of fogging and carrier development, on the basis of the developing current and a gradient of change in the developing current with respect to change in the DC component of the developing voltage, when the DC component of the developing voltage is the same as the surface potential of the photosensitive drum 5, and the developing current and a gradient of change in the developing current with respect to change in the DC component of the developing voltage, when the DC component of the developing voltage is a voltage for image formation (for forming an image as the developing roller 31 develops an electrostatic latent image with toner). In other words, the control unit 7 predicts whether or not it is a state where fogging easily occurs (or a state where fogging hardly occurs). In addition, the control unit 7 predicts whether or not it is a state where carrier development easily occurs (or a state where carrier development hardly occurs).

For the state prediction of fogging and carrier development, the following inequalities (1) and (2) are used.

0<A(P−Q)/(Vo−Vdc)<2.0×10⁻⁵ (1)

0<B×Q<4.0×10⁻³ (2)

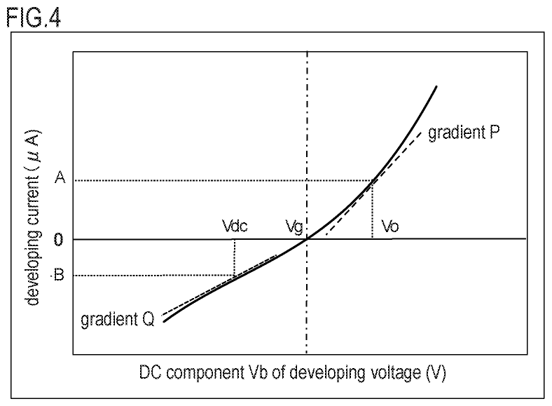

Parameters in the above inequalities (1) and (2) are described with reference to a graph illustrated in FIG. 4. FIG. 4 illustrates a relationship, related to development by the developing device 3, between a DC component Vb of the developing voltage and a developing current.

In the above inequalities (1) and (2), the surface potential of the photosensitive drum 5 is represented by Vo(V), the DC component of the developing voltage is represented by Vb(V), and the DC component of the developing voltage set for image formation is represented by Vdc(V).

In addition, the developing current when Vb=Vo holds is represented by A (μA), and a gradient of change in the developing current with respect to change in the developing voltage when Vb=Vo holds is represented by P (μA/V). In FIG. 4, the gradient P of change in the developing current with respect to change in the developing voltage when Vb=Vo holds is shown by a coarse broken line.

In addition, the developing current when Vb=Vdc holds is represented by −B (A), and a gradient of change in the developing current with respect to change in the developing voltage when Vb=Vdc holds is represented by Q (μA/V). In FIG. 4, the gradient Q of change in the developing current with respect to change in the developing voltage when Vb=Vdc holds is shown by a fine broken line.

The control unit 7 predicts a state of fogging on the basis of the above inequality (1). In other words, the control unit 7 predicts the state of fogging, on the basis of the developing current A when Vb=Vo holds, the gradient P of change in the developing current with respect to change in the developing voltage when Vb=Vo holds, and the gradient Q of change in the developing current with respect to change in the developing voltage when Vb=Vdc holds.

A value of “A(P−Q)” in the above inequality (1) corresponds to a value indicating unlikelihood of occurrence of fogging (hereinafter, referred to as fogging performance). As the fogging performance is smaller, fogging hardly occurs. As described later in detail, the control unit 7 predicts the state of fogging on the basis of the fogging performance after correction, which is obtained by dividing the value of “A(P−Q)” by a value of “Vo−Vdc”.

In addition, the control unit 7 predicts a state of carrier development on the basis of the above inequality (2). In other words, the control unit 7 predicts the state of carrier development on the basis of the developing current −B when Vb=Vdc holds, and the gradient Q of change in the developing current with respect to change in the developing voltage when Vb=Vdc holds.

A value of “B×Q” in the above inequality (2) corresponds to a value indicating unlikelihood of occurrence of carrier development (hereinafter, referred to as carrier development performance). As the carrier development performance is smaller, carrier development hardly occurs. As described later in detail, the control unit 7 predicts the state of carrier development on the basis of the carrier development performance.

In this embodiment, the states of fogging and carrier development are predicted utilizing the above method, and hence setting (changing) of the development conditions can be performed, so that fogging or carrier development will not occur regardless of fluctuation of the surface potential of the photosensitive drum 5. In this way, even if the surface potential of the photosensitive drum 5 fluctuates due to ambient environment (temperature, humidity, and the like) and a usage status (such as the number of printed sheets) of the image forming apparatus PR, fogging and carrier development can be suppressed. In other words, it is possible to suppress deterioration of image quality due to fluctuation of the surface potential of the photosensitive drum 5.

### <4-1. Prediction of State of Fogging>

When Vb=Vo holds, a potential difference between the developing roller 31 and the photosensitive drum 5 is zero. For this reason, the developing current that flows when Vb=Vo holds is a fogging current that is generated by fogging toner movement. The developing current that flows when Vb=Vo holds (i.e., the fogging current) corresponds to “A” in the above inequality (1).

Here, if a value of the fogging current as the developing current when Vb=Vo holds is regarded as the fogging performance, and if the development conditions are set using the fogging performance, fogging can occur when the surface potential of the photosensitive drum 5 fluctuates. For this reason, the value of the fogging current is multiplied by a change in the fogging current due to fluctuation of the surface potential of the photosensitive drum 5 (a “gradient of fogging current when Vb=Vo holds” described later), and hence the fogging performance is calculated.

In addition, originally, the fogging current when Vb=Vdc holds should be measured. However, because the fogging current is very small, it is hardly measured. For this reason, the fogging performance when Vb=Vdc holds is calculated on the basis of the fogging current when Vb=Vo holds.

When calculating the fogging performance in this way, it is preferred to perform correction using a value of a fogging margin voltage (Vo−Vdc) as a correction coefficient. As the fogging margin voltage is higher, the fogging performance is better. For this reason, the fogging performance before correction is divided by the fogging margin voltage, and the calculated value is regarded as the fogging performance.

### <4-2. Prediction of State of Carrier Development>

The developing current that flows when Vb=Vdc holds is a magnetic brush current that flows in the carrier in the magnetic brush. The developing current that flows when Vb=Vdc holds (i.e., the magnetic brush current) corresponds to “−B” in the above inequality (2).

As the magnetic brush current is larger, charges can be injected into the carrier more easily so that a charge amount of the carrier is increased, and carrier development becomes worse. In addition, also for the carrier development performance, similarly to the fogging performance, it is necessary to consider fluctuation of the surface potential of the photosensitive drum 5. For this reason, a value of the magnetic brush current is multiplied by a change in the magnetic brush current due to fluctuation of the surface potential of the photosensitive drum 5 (a “gradient of magnetic brush current when Vb=Vdc holds” described later), and hence the carrier development performance is calculated.

Note that, unlike the fogging performance, the carrier development performance is calculated on the basis of the developing current that flows when Vb=Vdc holds. For this reason, it is not necessary to perform the correction that is necessary for the fogging performance.

### <4-3. Developing Current, Fogging Current, and Magnetic Brush Current>

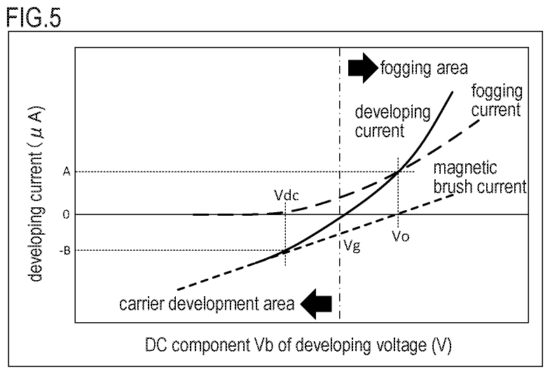

Hereinafter, with reference to a graph illustrated in FIG. 5, the developing current, the fogging current, and the magnetic brush current are described. In FIG. 5, a solid line shows a relationship, related to development by the developing device 3 between the DC component Vb of the developing voltage and the developing current. Further, in FIG. 5, a change in the fogging current is shown by a coarse broken line, while a change in the magnetic brush current is shown by a fine broken line.

First, the developing current can be expressed as follows.

developing current=fogging current+magnetic brush current

When Vb=Vo holds, the magnetic brush current does not flow, and it can be expressed as follows.

developing current=fogging current (A)

When Vb=Vdc holds, the fogging current hardly flows, and it can be expressed as follows.

developing current=magnetic brush current (−B)

Thus, by setting the development conditions so as to satisfy the following condition, even if the surface potential of the photosensitive drum 5 fluctuates, fogging or carrier development hardly occurs. Note that “A” in the following condition 1 is “A” in the above inequality (1), and “B” in the following condition 2 is “B” in the above inequality (2).

1. “A×(gradient of fogging current when Vb=Vo holds)/(Vo−Vdc)” is small.

2. “B×(gradient of magnetic brush current when Vb=Vdc holds)” is small.

Here, the gradient of fogging current when Vb=Vdc holds is much smaller than a gradient of the developing current, and is negligible. For this reason, when Vb=Vdc holds, the following relationship is satisfied.

gradient of magnetic brush current=gradient (Q) of developing current

In addition, the gradient of the magnetic brush current when Vb=Vdc holds is considered to be the same as the gradient of the magnetic brush current when Vb=Vo holds. For this reason, when Vb=Vo holds, the following relationship is satisfied.

gradient of fogging current=gradient (P) of developing current−gradient (Q) of magnetic brush current

From the above discussion, the condition for suppressing fogging is that a value of “A(P−Q)/(Vo−Vdc)” in the above inequality (1) is a certain level or less. In addition, the condition for suppressing carrier development is that a value of “B×Q” in the above inequality (2) is a certain level or less.

For instance, the image forming apparatus PR shifts to a development condition correction mode every predetermined period. The shift timing to the development condition correction mode is not particularly limited. The image forming apparatus PR may shift to the development condition correction mode every time when the accumulated number of printed sheets in it increases by a predetermined number. It may be possible to provide the image forming apparatus PR with an environment detection unit such as a temperature and humidity sensor, which detects an ambient environment of the image forming apparatus PR, and to shift to the development condition correction mode when a variation width of the ambient environment detected by the environment detection unit has satisfied a predetermined condition (e.g., when the ambient environment has changed largely). The image forming apparatus PR may shift to the development condition correction mode when it resumes from a sleep mode. The image forming apparatus PR may shift to the development condition correction mode when a user operates it.

When it shifts to the development condition correction mode, the control unit 7 changes the DC component of the developing voltage in a plurality of steps, and detects the developing current. Then, the control unit 7 calculates the value of “A(P−Q)/(Vo−Vdc)” in the above inequality (1), and predicts a state of fogging in accordance with whether or not the calculated value is within the range of the above inequality (1). In addition, the control unit 7 calculates the value of “B×Q” in the above inequality (2), and predicts a state of carrier development in accordance with whether or not the calculated value is within the range of the above inequality (2).

Further, when determining that it is a state where fogging can occur, the control unit 7 changes the development conditions so as to satisfy the above inequality (1). In addition, when determining that it is a state where carrier development can occur, the control unit 7 changes the development conditions so as to satisfy the above inequality (2).

By shifting to the development condition correction mode, and by changing the development conditions, if necessary, it is possible to suppress printing in the state where fogging can occur. In addition, it is possible to suppress printing in the state where carrier development can occur.

### <5. Confirmation Experiment>

Hereinafter, an experiment is described, which was performed for confirming effects of this embodiment. In this confirmation experiment, printing was actually performed, and states of printed images were checked.

### <5-1. Preparation of Toner>

The toner of the developer to be used for the confirmation experiment was prepared by the following method.

### <5-1-1. Synthesis of Amorphous Polyester Resin>

A reaction container, equipped with a thermometer (thermocouple), a dewatering conduit, a nitrogen gas introduction conduit, and a stirring device (stirring blade), was set in an oil bath. Then, 1,575 g of bisphenol A propylene oxide additive (BPA-PO), 163 g of bisphenol A ethylene oxide additive (BPA-EO), 377 g of fumaric acid, and 4 g of catalyst (dibutyltin oxide) were put into the reaction container.

After creating a nitrogen atmosphere in the reaction container, the temperature inside the reaction container was raised to 220 degrees Celsius while stirring the contents. Under the conditions of the nitrogen atmosphere and the temperature of 220 degrees Celsius, polymerization reaction of the contents in the reaction container was performed for 8 hours while removing by-product water. Next, the pressure inside the reaction container is reduced, and under the conditions of the reduced pressure atmosphere (pressure: 7,999 Pa) and the temperature of 220 degrees Celsius, the polymerization reaction of the contents in the reaction container was performed for more and 1 hour. In addition, the temperature inside the reaction container was reduced to 210 degrees Celsius, and then 336 g of trimellitic anhydride was added into the reaction container. Then, under the conditions of the reduced pressure atmosphere (pressure: 7,999 Pa) and the temperature of 210 degrees Celsius, reaction of the contents in the reaction container was performed. After that, the reaction product was taken out from the reaction container and was cooled, and hence the amorphous polyester resin having the following physical properties was obtained. Note that the polyester resin obtained in this way did not clearly show its endothermic peak in the endothermic curve measured using a differential scanning calorimeter, and its clear melting point was not able to be measured, and thus it was determined to be amorphous.
softening point (Tm): 100 degrees Celsius
glass transition point (Tg): 50 degrees Celsius
mass average molecular weight (Mw): 30,000
acid value: 15 mgKOH/g
hydroxyl value: 30 mgKOH/g

### <5-1-2. Preparation of Toner Mother Particles>

Using an FM mixer (“FM-10B” manufactured by Nippon Coke & Engineering Co., Ltd.), 100 pts. mass of binder resin, 4 pts. mass of coloring agent, 1 pts. mass of charge control agent, and 5 pts. mass of mold release agent were mixed, so that the mixture was obtained. As the binder resin, the amorphous polyester resin described above was used. As the coloring agent, copper phthalocyanine blue pigment (C.I. Pigment Blue 15:3) was used. As the charge control agent, quaternary ammonium salt (“BONTRON (registered trademark) P-51” manufactured by Orient Chemical Industries Co., Ltd.) was used. As the mold release agent, carnauba wax (“Special Carnauba Wax 1st” manufactured by S. KATO & CO.) was used.

Next, using a twin-screw extruder (“PCM-30 type” manufactured by Ikegai Co., Ltd.), the mixture was melted and kneaded, so that the melted and kneaded material was obtained. In addition, using a mechanical pulverizer (“Turbo Mill” manufactured by Freund-Turbo Corporation), the melted and kneaded material was pulverized, so that the pulverized material was obtained. Then, using a classifier (“Elbow Jet” manufactured by Nittetsu Mining Co., Ltd.), the pulverized material was classified. In this way, powder-like toner mother particles having a volume median diameter of 6.8 m were obtained. Note that the volume median diameter (D₅₀) is a median diameter measured using a laser diffraction/scattering type particle size distribution measurement device (“LA-950” manufactured by HORIBA, Ltd.).

### <5-1-3. External Addition to Toner Mother Particles>

Using the FM mixer (“FM-10B” manufactured by Nippon Coke & Engineering Co., Ltd.), 100.0 pts. mass of the toner mother particle described above, 1.0 pts. mass of the silica particles (mean primary particle diameter: 20 nm), and 0.75 pts. mass of aluminum oxide particles (“AEROXIDE (registered trademark) Alu C805” manufactured by Nippon Aerosil Co., Ltd., BET specific surface area: 75 to 105 m²/g) were mixed for 5 minutes under the condition of 4,000 rpm, so that the mixture was obtained. Note that the mean primary particle diameter of the aluminum oxide particles is more than 300 nm. Then, using a sieve of 200 mesh (aperture of 75 m), the mixture was sieved, and the toner shown in Table 1 was obtained. In the following description, the toner is shown by “T”.

TABLE 1
toner (T)

| mother | external additive particle | |
|---|---|---|
| particle | alumina particle | silica particle |

| pts. mass | pts. mass | pts. mass | diameter (nm) |
|---|---|---|---|
| 100 | 0.75 | 1 | 20 |

### <5-2. Preparation of Carrier>

The carrier of the developer to be used for the confirmation experiment was prepared by the following method.

### <5-2-1. Preparation of Coating Liquid>

Coat resin solution, at least one of the barium titanate particles and the carbon black particles, and toluene were put into a stainless steel container. Then, using a homogenizer, the contents in the stainless steel container were mixed, so that the coating liquid was obtained. As the barium titanate particles, “BT-01” manufactured by Sakai Chemical Industry Co., Ltd. (mean primary particle diameter: 304 nm) was used. As the carbon black particle, “Ketjenblack (registered trademark) EC300J” manufactured by LION SPECIALTY CHEMICALS CO., Ltd. (mean primary particle diameter: 39.5 nm), which is conductive carbon black, was used.

### <5-2-2. Preparation of Carrier Particles>

Using a fluid bed coating machine (“FD-MP-01 D type” manufactured by Powrex Corporation), 5,000 g of the carrier cores were allowed to flow, while the coating liquid was sprayed to the carrier cores. In this way, the carrier cores coated with the coating liquid were obtained. In this case, as the carrier cores, manganese ferrite cores (manufactured by DOWA IP Creation Co., Ltd., volume median diameter: 40 μm) were used. Next, using an electric furnace, the carrier cores coated with the coating liquid were fired at 200 degrees Celsius for 1 hour, so that the coat layer was formed on the surface of the carrier core. In this way, the carrier particles were obtained.

Here, in the confirmation experiment, five type of carriers, i.e., carriers C1 to C5 were used. In other words, five type of developers were used. Characteristics of the carriers C1 to C5 are shown in Table 2. Note that each toner of the five type of developers is the toner T described above.

TABLE 2
carrier

| | | volume average | saturation | |
|---|---|---|---|---|
| | | particle diameter | magnetization | |
| type | coat resin | (μm) | (emu/g) | Log₁₀R |
| C1 | silicone | 39 | 80 | 10 |
| C2 | fluorocarbon | 35 | 70 | 9 |
| C3 | silicone | 39 | 70 | 9 |
| C4 | silicone | 39 | 80 | 9 |
| C5 | silicone | 39 | 80 | 8 |

As illustrated in Table 2, in the carriers C1 and C3 to C5, the coat layer coating the carrier core was made of silicone resin. As the silicone resin, “KR-255” manufactured by Shin-Etsu Chemical Co., Ltd. (solid content: methylphenyl silicone resin, solid content concentration: 50 mass %) was used. In the carrier C2, the coat layer coating the carrier core was made of fluorocarbon resin.

In addition, the volume average particle diameter of the carriers C1 and C3 to C5 is 39 μm. The volume average particle diameter of the carrier C2 is 35 μm.

In addition, a saturation magnetization of the carriers C1, C4, and C5 is 80 emu/g. The saturation magnetization of the carriers C2 and C3 is 70 emu/g. The saturation magnetization of the carrier is a value measured using a sensitive vibrating sample magnetometer (“VSM-P7” manufactured by Toei Industry Co., Ltd.) under the condition of an external magnetic field of 3,000 (Oe).

In addition, when a carrier resistance is R (unit: Q), a value of “log₁₀R” of the carrier C1 is approximately 10. A value of “log₁₀R” of the carriers C2 to C4 is approximately 9. A value of “log₁₀R” of the carrier C5 is approximately 8. Note that the carrier resistance is determined on the basis of a measurement result using a bridge method.

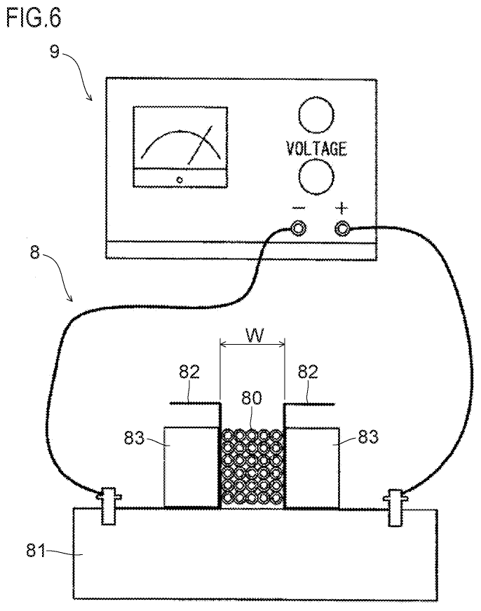

In measurement of the carrier resistance, as illustrated in FIG. 6, a bridge type resistance measuring device 8 and a super megohmmeter 9 (“SM-8220” manufactured by HIOKI E.E. Corporation) are used. The bridge type resistance measuring device 8 has a pair of electrode plates 82 fixed on a top surface of a substrate 81 made of acrylic resin. The pair of electrode plates 82 are disposed to face each other with a space W of 1 mm. Surfaces of the pair of electrode plates 82 face each other. A magnet 83 of 1,000 gauss is disposed on each back side of the pair of electrode plates 82. The facing side of each magnet 83 has an area of 3 cm². In this way, a magnetic field is formed between the pair of electrode plates 82.

A carrier sample 80 is set between the pair of electrode plates 82. The amount of the set carrier sample 80 is 0.2 g. The carrier sample 80 is filled between the pair of electrode plates 82, so as to have a chain structure along magnetic field lines. In this state, a DC voltage of 1,000 V (an electric field of 1×10⁶ V/m) is applied between the terminals, and ten seconds later the resistance value is read by the super megohmmeter 9, and the read value (unit: Ω) is the carrier resistance (the value of the above “R”).

### <5-3. Evaluation>

Using an image forming apparatus (Taskalfa2554ci (a modified machine)) manufactured by KYOCERA Document Solutions Inc. as an evaluation machine, Experiments 1 to 24 were performed. In Experiments 1 to 24, three types of environment, i.e., high temperature and high humidity (32.5 degrees Celsius, 80% RH), low temperature and low humidity (10 degrees Celsius, 15% RH), and normal temperature and normal humidity (23 degrees Celsius, 50% RH) are appropriately changed, and a pattern having a coverage rate of 5% was continuously printed on 100,000 sheets of A4 landscape size.

In Experiments 1 to 24, the surface potential of the photosensitive drum Vo was set to 450, an AC amplitude of the developing voltage (AC component) was set to 1,200 V, and an AC frequency was set to 5 KHz. The developing voltage (DC component) Vdc for image formation was set to any one of 300 V, 320 V, 330 V, 350 V, 360 V, 370 V, and 380 V. In addition, any one of the carriers C1 to C5 was mixed in the developer that was used in each of Experiments 1 to 24. Experiment conditions of Experiments 1 to 24 are shown in Table 3.

TABLE 3

| | | Vo | Vdc | A | B | P | Q |
|---|---|---|---|---|---|---|---|
| No. | carrier | (V) | (V) | (μA) | (μA) | (μA/V) | (μA/V) |
| 1 | C1 | 450 | 350 | 2.5 × 10⁻¹ | 1.7 × 10⁻¹ | 5.2 × 10⁻³ | 3.7 × 10⁻³ |
| 2 | C1 | 450 | 300 | 2.5 × 10⁻¹ | 3.6 × 10⁻¹ | 5.2 × 10⁻³ | 4.0 × 10⁻³ |
| 3 | C1 | 450 | 320 | 2.5 × 10⁻¹ | 2.8 × 10⁻¹ | 5.2 × 10⁻³ | 3.8 × 10⁻³ |
| 4 | C1 | 450 | 380 | 2.5 × 10⁻¹ | 5.7 × 10⁻² | 5.2 × 10⁻³ | 3.9 × 10⁻³ |
| 5 | C1 | 450 | 330 | 2.5 × 10⁻¹ | 2.5 × 10⁻¹ | 5.2 × 10⁻³ | 3.7 × 10⁻³ |
| 6 | C1 | 450 | 370 | 2.5 × 10⁻¹ | 9.6 × 10⁻² | 5.2 × 10⁻³ | 3.8 × 10⁻³ |
| 7 | C2 | 450 | 300 | 2.4 × 10⁻¹ | 1.3 × 10⁻¹ | 5.8 × 10⁻³ | 8.4 × 10⁻⁴ |
| 8 | C2 | 450 | 320 | 2.4 × 10⁻¹ | 1.2 × 10⁻¹ | 5.8 × 10⁻³ | 9.4 × 10⁻⁴ |
| 9 | C2 | 450 | 330 | 2.4 × 10⁻¹ | 1.1 × 10⁻¹ | 5.8 × 10⁻³ | 1.1 × 10⁻³ |
| 10 | C3 | 450 | 300 | 7.1 × 10⁻¹ | 4.7 × 10⁻¹ | 1.1 × 10⁻² | 9.5 × 10⁻³ |
| 11 | C4 | 450 | 300 | 2.1 × 10⁻¹ | 6.0 × 10⁻¹ | 9.7 × 10⁻³ | 6.7 × 10⁻³ |
| 12 | C4 | 450 | 320 | 2.1 × 10⁻¹ | 4.8 × 10⁻¹ | 9.7 × 10⁻³ | 5.1 × 10⁻³ |
| 13 | C2 | 450 | 350 | 2.4 × 10⁻¹ | 8.3 × 10⁻² | 5.8 × 10⁻³ | 1.4 × 10⁻³ |
| 14 | C2 | 450 | 380 | 2.4 × 10⁻¹ | 2.9 × 10⁻² | 5.8 × 10⁻³ | 2.3 × 10⁻³ |
| 15 | C2 | 450 | 370 | 2.4 × 10⁻¹ | 5.0 × 10⁻² | 5.8 × 10⁻³ | 1.9 × 10⁻³ |
| 16 | C3 | 450 | 320 | 7.1 × 10⁻¹ | 3.0 × 10⁻¹ | 1.1 × 10⁻² | 8.0 × 10⁻³ |
| 17 | C4 | 450 | 350 | 2.1 × 10⁻¹ | 3.5 × 10⁻¹ | 9.7 × 10⁻³ | 3.9 × 10⁻³ |
| 18 | C4 | 450 | 380 | 2.1 × 10⁻¹ | 2.3 × 10⁻¹ | 9.7 × 10⁻³ | 4.1 × 10⁻³ |
| 19 | C5 | 450 | 300 | 4.8 × 10⁻¹ | 6.1 × 10⁻¹ | 1.1 × 10⁻² | 7.5 × 10⁻³ |
| 20 | C5 | 450 | 320 | 4.8 × 10⁻¹ | 4.7 × 10⁻¹ | 1.1 × 10⁻² | 6.6 × 10⁻³ |
| 21 | C3 | 450 | 350 | 7.1 × 10⁻¹ | 8.0 × 10⁻² | 1.1 × 10⁻² | 6.7 × 10⁻³ |
| 22 | C4 | 450 | 400 | 2.1 × 10⁻¹ | 1.4 × 10⁻¹ | 9.7 × 10⁻³ | 5.0 × 10⁻³ |
| 23 | C5 | 450 | 350 | 4.8 × 10⁻¹ | 2.8 × 10⁻¹ | 1.1 × 10⁻² | 6.0 × 10⁻³ |
| 24 | C5 | 450 | 380 | 4.8 × 10⁻¹ | 9.9 × 10⁻² | 1.1 × 10⁻² | 6.4 × 10⁻³ |

In addition, in Experiments 1 to 24, fogging and carrier development are each evaluated. In evaluation of fogging, for each Experiment, in the printed results of 100,000 sheets, a part of worst fogging was set as an evaluation target. In evaluation of carrier development, for each Experiment, in the printed results of 100,000 sheets, a part of worst carrier development was set as an evaluation target.

In evaluation of fogging, using a white color photometer (“TC-6DS” manufactured by Tokyo Denshoku Co., Ltd.), a reflection density (D) of a blank area in the evaluation target sheet was measured. In addition, a reflection density (Do) of an unprinted sheet was measured, and a fogging density (=D−Do) was calculated. Then, the evaluation was performed by the following criteria.
A (particularly good): fogging density is less than 0.01.
B (good): fogging density is 0.01 or more and less than 0.02.
C (defective): fogging density is 0.02 or more.

In the evaluation of carrier development, because numerical evaluation is difficult, white spotting in the evaluation target (a half image having an image density of 25%) was visually checked. Then, the evaluation was performed by the following criteria.
A (particularly good): white spotting has hardly occurred.
B (good): white spotting has occurred a little, but is not a problem.
C (defective): white spotting has occurred and is a problem.

Evaluation results of Experiments 1 to 24 are shown in Table 4. The column of fogging in each Experiment shows the fogging density (FD). Note that the column of comprehensive evaluation in each Experiment shows a result of comprehensive evaluation of states of fogging and carrier development. The evaluation result A means that the image quality was particularly good, the evaluation result B means that the image quality was good, and the evaluation result C means that there was a problem in the image quality.

TABLE 4

| | fogging | | carrier development | comprehensive |
|---|---|---|---|---|
| No. | FD | evaluation | evaluation | evaluation |
| 1 | 0.004 | A | A | A |
| 2 | 0.002 | A | A | A |
| 3 | 0.003 | A | A | A |
| 4 | 0.005 | A | A | A |
| 5 | 0.003 | A | A | A |
| 6 | 0.004 | A | A | A |
| 7 | 0.008 | A | A | A |
| 8 | 0.009 | A | A | A |
| 9 | 0.010 | A | A | A |
| 10 | 0.009 | A | C | C |
| 11 | 0.004 | A | C | C |
| 12 | 0.008 | A | B | B |
| 13 | 0.011 | B | A | B |
| 14 | 0.012 | B | A | B |
| 15 | 0.012 | B | A | B |
| 16 | 0.018 | B | B | B |
| 17 | 0.012 | B | A | B |
| 18 | 0.017 | B | A | B |
| 19 | 0.011 | B | C | C |
| 20 | 0.016 | B | B | B |
| 21 | 0.033 | C | A | C |
| 22 | 0.020 | C | A | C |
| 23 | 0.023 | C | A | C |
| 24 | 0.031 | C | A | C |

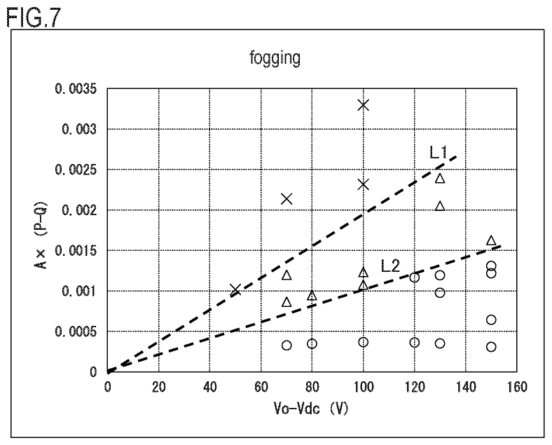

In addition, the evaluation results of fogging of the Experiments were plotted in a graph, in which the vertical axis represents “A(P−Q)” in the above inequality (1) while the horizontal axis represents “Vo−Vdc” in the above inequality (1), as illustrated in FIG. 7. In the graph of FIG. 7, a circle mark indicates the evaluation result A, a triangle mark indicates the evaluation result B, and an x mark indicates the evaluation result C.

In the graph of FIG. 7, a boundary between an area of the evaluation result C and an area of the evaluation result B can be shown by a line L1. When a value of “A(P−Q)/(Vo−Vdc)” is 2.0×10⁻⁵, a relationship between “A(P−Q)” and “Vo−Vdc” is shown by the line L1. In this way, it can be said that fogging can be suppressed when the above inequality (1) is satisfied.

Further, in the graph of FIG. 7, a boundary between the area of the evaluation result B and an area of the evaluation result A can be shown by a line L2. When a value of “A(P−Q)/(Vo−Vdc)” is 1.0×10⁻⁵, a relationship between “A(P−Q)” and “Vo−Vdc” is shown by the line L2. In this way, it can be said that it is more preferred to satisfy the following inequality (3) in order to suppress fogging.

0<A(P−Q)/(Vo−Vdc)<1.0×10⁻⁵ (3)

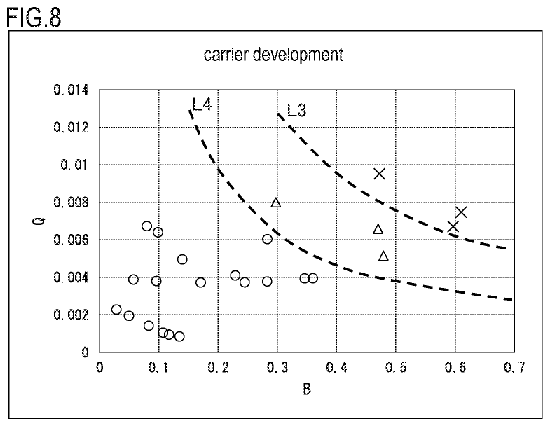

In addition, the evaluation results of carrier development of the Experiments were plotted in a graph, in which the vertical axis represents “Q” in the above inequality (2) while the horizontal axis represents “B” in the above inequality (2), as illustrated in FIG. 8. In the graph of FIG. 8, a circle mark indicates the evaluation result A, a triangle mark indicates the evaluation result B, and an x mark indicates the evaluation result C.

In the graph of FIG. 8, a boundary between the area of the evaluation result C and the area of the evaluation result B can be shown by a line L3. When a value of “B×Q” is 4.0×10⁻³, a relationship between “Q” and “B” is shown by the line L3. In this way, it can be said that carrier development can be suppressed when the above inequality (2) is satisfied.

Further, in the graph of FIG. 8, a boundary between the area of the evaluation result B and the area of the evaluation result A can be shown by a line L4. When a value of “B×Q” is 2.0×10⁻³, a relationship between “Q” and “B” is shown by the line L4. In this way, it can be said that it is more preferred to satisfy the following inequality (4) in order to suppress carrier development.

0<B×Q<2.0×10⁻³ (4)

The embodiment disclosed this time is merely an example in every aspect, and should not be considered as a limitation. The scope of the present disclosure is defined not by the above description of the embodiment but by the claims, and it includes all modifications within meaning and scope equivalent to the claims.

What is claimed is:

1. An image forming apparatus comprising:
an image carrier having a surface on which an electrostatic latent image is formed;
a developer carrier having a developer carrying surface configured to carry a two-component developer containing toner and carrier, the developer carrier developing the electrostatic latent image with the toner on the developer carrying surface, so as to form an image;
a development power supply configured to apply the developer carrier with a developing voltage including a DC component;
a current detection unit configured to output a value corresponding to a developing current flowing between the developer carrier and the image carrier when the developing voltage is applied to the developer carrier; and
a control unit configured to detect the developing current on the basis of the output of the current detection unit, wherein
the control unit detects the developing current while changing the DC component of the developing voltage in a plurality of steps, and predicts states of fogging and carrier development, on the basis of the developing current and a gradient of change in the developing current with respect to change in the DC component of the developing voltage, when the DC component of the developing voltage is the same as a surface potential of the image carrier, and the developing current and a gradient of change in the developing current with respect to change in the DC component of the developing voltage, when the DC component of the developing voltage is a voltage for image formation by the developer carrier.

2. The image forming apparatus according to claim 1, wherein
supposing that a surface potential of the image carrier is Vo(V), the DC component of the developing voltage is Vb(V), and the DC component of the developing voltage set for image formation is Vdc(V), and
supposing that the developing current when Vb=Vo holds is A (μA), a gradient of change in the developing current with respect to change in the developing voltage when Vb=Vo holds is P (μA/V), the developing current when Vb=Vdc holds is −B (μA), and a gradient of change in the developing current with respect to change in the developing voltage when Vb=Vdc holds is Q (μA/V), then the following inequalities (1) and (2) are satisfied.
0<A(P−Q)/(Vo−Vdc)<2.0×10⁻⁵ (1)
0<B×Q<4.0×10⁻³ (2)

3. The image forming apparatus according to claim 2, wherein the following inequalities (3) and (4) are satisfied.
0<A(P-Q)/(Vo-Vdc)<1.0×10⁻⁵ (3)
0<B×Q<2.0×10⁻³ (4)
